(19) United States
(12) Patent Application Publication
(10) Pub. No.: US 2020/0278768 A1
(43) Pub. Date: Sep. 3, 2020

(54) ELECTRONIC BLACKBOARD AND CONTROL METHOD THEREOF

(71) Applicant: Samsung Electronics Co., Ltd., Suwon-si, Gyeonggi-do (KR)

(72) Inventors: Sang-ho KIM, Hwaseong-si, Gyeonggi-do (KR); Gwan-hyung KIM, Suwon-si, Gyeonggi-do (KR); Ji-hye HA, Suwon-si, Gyeonggi-do (KR)

(21) Appl. No.: 16/650,145

(22) PCT Filed: Aug. 30, 2018
(86) PCT No.: PCT/KR2018/010055

§ 371 Date: Mar. 24, 2020

(30) Foreign Application Priority Data
Sep. 26, 2017 (KR) 10-2017-0124424

(51) Int. Cl. G06F 3/041; G06F 3/0354; G06F 3/042; G06T 7/90

(52) U.S. Cl. CPC G06F 3/0416; G06T 7/90; G06F 3/042; G06F 3/03545

(57) ABSTRACT

The disclosure relates to a digital whiteboard, the digital whiteboard including: a display; a first sensor configured to detect a touch position of a writing instrument with regard to a screen of the display; a second sensor configured to obtain an image based on image capturing; and a processor configured to identify a target region, in which a motion is present, in the image by comparing a series of images captured by the second sensor, identify a color of the writing instrument in the identified target region, and display an image comprising the identified color, at a position corresponding to a touch of the writing instrument on the screen of the display.

Thus, the color of the writing instrument touching the screen of the display is automatically identified, and the traces of the writing instrument are displayed with the identified color on the screen, thereby giving a user an experience as if the user directly writes with the corresponding writing instrument on the digital whiteboard.

### TECHNICAL FIELD

The disclosure relates to a digital whiteboard and a method of controlling the same, and more particularly to a digital whiteboard and a method of controlling the same, in which a touch position and a color of a writing instrument that touches a screen of the digital whiteboard are detectable.

### BACKGROUND ART

A display apparatus capable of detecting a touch may be used to achieve a digital whiteboard or an electronic notepad. In other words, a display apparatus, which can detect a touch position of a writing instrument that touches a screen of the display apparatus and display an image on the screen based on traces of the detected touch positions, may perform the functions of the digital whiteboard or electronic notepad.

When the display apparatus is used as the digital whiteboard, a user may want the traces of the writing instrument to be displayed with various colors as well as black on the screen of the digital whiteboard.

To meet the user's want, one of the related arts has provided a user interface (UI) that allows a user to select a color, which will be represented according to the traces of the writing instrument, in a menu of the digital whiteboard. However, it is inconvenient for a user to select a desired color in the menu every time the user wants color change.

### Technical Problem

Accordingly, an aspect of the disclosure is to provide a digital whiteboard which automatically identifies a color of a writing instrument touching a screen of a digital whiteboard and displays an image having the color on the screen.

Another aspect of the disclosure is to provide a digital whiteboard which detects a touch position of a writing instrument on a screen thereof, rapidly identifies the color of the writing instrument before displaying traces of the detected touch positions, and displays the traces with the identified color, thereby giving a user an experience as if the user directly writes with the holding writing instrument on the digital whiteboard.

### Technical Solution

According to an embodiment of the disclosure, there is provided a digital whiteboard comprising: a display; a first sensor configured to detect a touch position of a writing instrument with regard to a screen of the display; a second sensor configured to obtain an image based on image capturing; and a processor configured to identify a target region, in which a motion is present, in the image by comparing a series of images captured by the second sensor, identify a color of the writing instrument in the identified target region, and display an image comprising the identified color, at a position corresponding to a touch of the writing instrument on the screen of the display. Thus, according to the disclosure, the color of the writing instrument touching the screen of the display is automatically identified, and the traces of the writing instrument are displayed with the identified color on the screen, thereby giving a user an experience as if the user directly writes with the corresponding writing instrument on the digital whiteboard. Further, according to the disclosure, the color of the writing instrument is rapidly identified before detecting the touch position of the writing instrument on the screen of the digital whiteboard and the traces of the writing instrument are displayed with the identified color, thereby giving a user an experience as if the user writes down with the writing instrument immediately having its own color from the beginning of the writing without mirroring the color of the writing instrument only after starting the writing.

The processor may identify a color, which is most similar to a color of the target region, among a plurality of preset colors as the color of the writing instrument. Thus, it is possible to rapidly identify the color of the writing instrument from the target region, without specifically recognizing the detailed shape, pattern, kind, etc. of an object corresponding to the writing instrument.

The processor may identify the color of the writing instrument based on a distance between the writing instrument and a human body holding the writing instrument. Thus, the size of the region targeted for identifying the color of the writing instrument is reduced, thereby not only speeding up the color identification but also improving the accuracy in identifying the color the color of the writing instrument.

The processor may identify the color of the writing instrument based on density of color distribution in the target region. Further, the processor may identify the color of the writing instrument based on information in which a color component unrelated to the writing instrument is excluded from color distribution of the target region. Thus, it is possible to improve the accuracy of identifying the color of the writing instrument while keeping the high speed of identifying the color of the writing instrument.

The processor may identify a color, which is continuously shown in a predetermined direction within the target region, as the color of the writing instrument. Thus, it is possible to improve reliability of identifying the color of the writing instrument.

The processor may maintain a previously detected color of the writing instrument when detection of the writing instrument is stopped and then resumed within a predetermined period of time. Thus, when a user discontinuously performs writing down with one writing instrument, it is possible to use the already identified color of the writing instrument again as it is, thereby rapidly identifying the color of the writing instrument.

The processor may detect motions of a first writing instrument and a second writing instrument by assigning individual regions in the image to each writing instrument. Thus, it is possible to rapidly identify the color of the writing instrument even when the plurality of writing instruments is used.

According to an embodiment of the disclosure, there is provided a digital whiteboard comprising: a display; at least one first sensor configured to detect a touch position of a writing instrument on the display based on a detection signal, and color information of the writing instrument based on a reflection signal of the detection signal reflected from the writing instrument; and a processor configured to display an image comprising the writing instrument, of which a color is identified based on the detected color information, at a position corresponding to a touch of the writing instrument on a screen of the display. Thus, only one sensor is enough to detect both the color and touch position of the writing instrument, thereby reducing production costs of the digital whiteboard and improving a design degree of freedom as compared with those of individually provided sensors. Further, it is possible to more rapidly identify the color of the writing instrument because the color of the writing instrument is detectable without capturing an image.

The detection signal may comprise a plurality of signals different in wavelength. Further, the first sensor may comprise a signal emitter configured to emit an infrared signal, and a signal receiver configured to receive the infrared signal.

According to an embodiment of the disclosure, there is provided a method of controlling a digital whiteboard, comprising: identifying a target region, in which a motion is present, in an image by comparing a series of captured images; identifying a color of the writing instrument in the identified target region; identifying a touch position of the writing instrument on a screen of the digital whiteboard; and displaying an image comprising the identified color, at a position corresponding to a touch of the writing instrument on the screen of the digital whiteboard. Thus, according to the disclosure, the color of the writing instrument touching the screen of the display is automatically identified, and the traces of the writing instrument are displayed with the identified color on the screen, thereby giving a user an experience as if the user directly writes with the corresponding writing instrument on the digital whiteboard. Further, according to the disclosure, the color of the writing instrument is rapidly identified before detecting the touch position of the writing instrument on the screen of the digital whiteboard and the traces of the writing instrument are displayed with the identified color, thereby giving a user an experience as if the user writes down with the writing instrument immediately having its own color from the beginning of the writing without mirroring the color of the writing instrument only after starting the writing.

The identifying the color of the writing instrument may comprise identifying a color, which is most similar to a color of the target region, among a plurality of preset colors as the color of the writing instrument. Thus, it is possible to rapidly identify the color of the writing instrument from the target region, without specifically recognizing the detailed shape, pattern, kind, etc. of an object corresponding to the writing instrument.

The identifying the color of the writing instrument may comprise identifying the color of the writing instrument based on a distance between the writing instrument and a human body holding the writing instrument. Thus, the size of the region targeted for identifying the color of the writing instrument is reduced, thereby not only speeding up the color identification but also improving the accuracy in identifying the color the color of the writing instrument.

The identifying the color of the writing instrument may comprise identifying the color of the writing instrument based on density of color distribution in the target region. Further, the identifying the color of the writing instrument may comprise identifying the color of the writing instrument based on information in which a color component unrelated to the writing instrument is excluded from color distribution of the target region. Thus, it is possible to improve the accuracy of identifying the color of the writing instrument while keeping the high speed of identifying the color of the writing instrument.

The identifying the color of the writing instrument may comprise identifying a color, which is continuously shown in a predetermined direction within the target region, as the color of the writing instrument. Thus, it is possible to improve reliability of identifying the color of the writing instrument.

The identifying the color of the writing instrument may comprise maintaining a previously detected color of the writing instrument when detection of the writing instrument is stopped and then resumed within a predetermined period of time. Thus, when a user discontinuously performs writing down with one writing instrument, it is possible to use the already identified color of the writing instrument again as it is, thereby rapidly identifying the color of the writing instrument.

The identifying the target region may comprise detecting motions of a first writing instrument and a second writing instrument by assigning individual regions in the image to each writing instrument. Thus, it is possible to rapidly identify the color of the writing instrument even when the plurality of writing instruments is used.

According to an embodiment of the disclosure, there is provided a method of controlling a digital whiteboard, comprising: detecting a touch position of a writing instrument on the display based on a detection signal, and color information of the writing instrument based on a reflection signal of the detection signal reflected from the writing instrument; and displaying an image comprising the writing instrument, of which a color is identified based on the detected color information, at a position corresponding to a touch of the writing instrument on a screen of the display. Thus, only one sensor is enough to detect both the color and touch position of the writing instrument, thereby reducing production costs of the digital whiteboard and improving a design degree of freedom as compared with those of individually provided sensors. Further, it is possible to more rapidly identify the color of the writing instrument because the color of the writing instrument is detectable without capturing an image.

The detection signal may comprise a plurality of signals different in wavelength.

A computer program according to an embodiment of the disclosure includes a computer program stored in a medium to execute one of the control methods combined to the digital whiteboard.

The computer program may be stored in a medium of the server and downloadable into the digital whiteboard through a network.

### Advantageous Effects

As described above, according to the disclosure, the color of the writing instrument touching the screen of the display is automatically identified, and the traces of the writing instrument are displayed with the identified color on the screen.

Further, according to the disclosure, the color of the writing instrument is rapidly identified before detecting the touch position of the writing instrument on the screen of the digital whiteboard and the traces of the writing instrument are displayed with the identified color, thereby giving a user an experience as if the user directly writes down on the digital whiteboard with the writing instrument.

### DESCRIPTION OF DRAWINGS

FIG. 1 illustrates a digital whiteboard according to an embodiment of the disclosure,

FIG. 2 illustrates a configuration of a digital whiteboard according to an embodiment of the disclosure,

FIG. 3 illustrates a method of controlling a digital whiteboard according to an embodiment of the disclosure,

FIG. 4 illustrates an example of a second sensor according to an embodiment of the disclosure,

FIG. 5 illustrates an example of a method of identifying a target region according to an embodiment of the disclosure,

FIG. 6 illustrates a method of controlling a digital whiteboard, which includes an example of a method of identifying a color of a writing instrument according to an embodiment of the disclosure,

FIG. 7 illustrates another example of a method of identifying a color of a writing instrument according to an embodiment of the disclosure,

FIG. 8 illustrates still another example of a method of identifying a color of a writing instrument according to an embodiment of the disclosure,

FIG. 9 illustrates still another example of a method of identifying a color of a writing instrument according to an embodiment of the disclosure,

FIG. 10 illustrates still another example of a method of identifying a color of a writing instrument according to an embodiment of the disclosure,

FIG. 11 illustrates an example of using a digital whiteboard according to another embodiment of the disclosure,

FIG. 12 illustrates a configuration of a digital whiteboard according to still another embodiment of the disclosure,

FIG. 13 illustrates an example of a digital whiteboard according to still another embodiment of the disclosure, and

FIG. 14 illustrates a color detection method of a digital whiteboard according to still another embodiment of the disclosure.

### BEST MODE

Below, embodiments of the disclosure will be described in detail with reference to the accompanying drawings. In the drawings, like numerals or symbols refer to like elements having substantially the same function, and the size of each element may be exaggerated for clarity and convenience of description. However, the technical concept of the disclosure and its key configurations and functions are not limited to those described in the following embodiments. In the following descriptions, details about publicly known technologies or configurations may be omitted if they unnecessarily obscure the gist of the disclosure.

In the following embodiments, terms ‘first’, ‘second’, etc. are used only to distinguish one element from another, and singular forms are intended to include plural forms unless otherwise mentioned contextually. In the following embodiments, it will be understood that terms ‘comprise’, ‘include’, ‘have’, etc. do not preclude the presence or addition of one or more other features, numbers, steps, operation, elements, components or combination thereof. In addition, a ‘module’ or a ‘portion’ may perform at least one function or operation, be achieved by hardware, software or combination of hardware and software, and be integrated into at least one module for at least one processor.

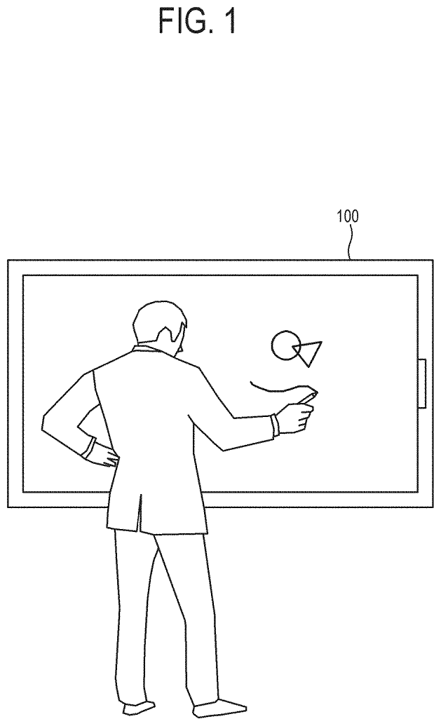

FIG. 1 illustrates a digital whiteboard according to an embodiment of the disclosure. The digital whiteboard 100 according to an embodiment of the disclosure may for example be achieved by a television (TV). Further, the digital whiteboard 100 according to another embodiment of the disclosure may for example be achieved by a smartphone, a tablet computer, a mobile phone, a smartwatch, a head-mountable display or the like wearable device, a computer, a multimedia player, an electronic frame, a digital billboard, a large format display (LFD), a digital signage, a set-top box, refrigerator, etc. However, the digital whiteboard 100 according to an embodiment of the disclosure is not limited to these examples, and may include any apparatus capable of detecting a touch and outputting an image.

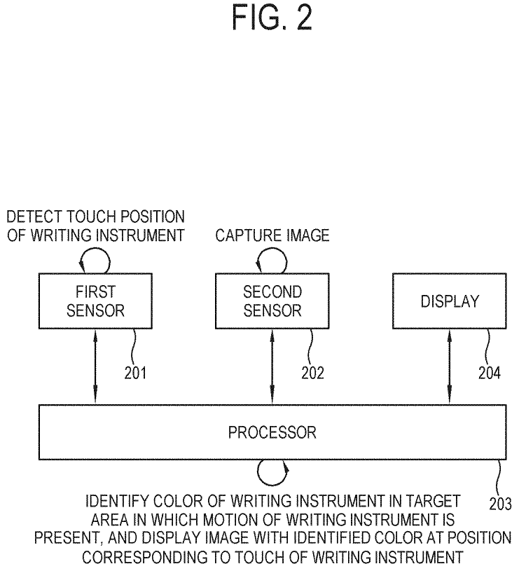

FIG. 2 illustrates a configuration of a digital whiteboard 100 according to an embodiment of the disclosure. The digital whiteboard 100 according to an embodiment of the disclosure includes a first sensor 201, a second sensor 202, a processor 203 and a display 204. However, the configuration of the digital whiteboard 100 shown in FIG. 2 is merely an example, and the digital whiteboard 100 according to an embodiment of the disclosure may be achieved by another configuration. That is, the digital whiteboard 100 according to an embodiment of the disclosure may include another element in addition to the configuration shown in FIG. 2, or exclude some elements from the configuration shown in FIG. 2.

The first sensor 201 detects a touch position of a writing instrument on the screen of the display 204. Here, the writing instrument refers to an object that touches the screen of the display 204 and leaves writing traces, and there are no limits to the kinds of object. For example, the writing instrument may be a stylus pen, may be a thin and long object such as a general pen, a bar, etc. and may be a Lego block, a toy, a fruit or the like object generally less relevant to a pen. Further, a human's body may also be used as the writing instrument.

The first sensor 201 may be achieved by any kind of sensor capable of detecting a touch or pressure of the writing instrument. For example, the first sensor 201 may include a pressure sensor or a touch sensor of a capacitive overlay type, a resistive overlay type, an infrared beam type, etc. The first sensor 201 generates a reception signal when receiving a touch input of the writing instrument, and transmits the reception signal to the processor 203.

The second sensor 202 generates an image by photographing the surroundings of the display 204. In particular, the second sensor 202 generates an image by photographing the writing instrument to be used in touching the screen of the display 204 and transmits the image to the processor 203.

The second sensor 202 may for example be achieved by a camera. The camera may include a lens through which incident light enters, and a complementary metal oxide semiconductor (CMOS) or charge coupled device (CCD) image sensor for detecting the incident light.

The processor 203 performs image processing based on signals transmitted from the first sensor 201 and the second sensor 202, and controls the processing results to be displayed on the display 204. The processor 203 may be achieved by one or more hardware and/or software modules for performing the foregoing processing, or combination thereof.

The processor 203 may perform control for operating generating elements of the digital whiteboard 100. For example, the processor 203 may control the first sensor 201 to receive a touch input, control the second sensor 202 to capture and obtain an image, and control the display 204 to display an image.

The processor 203 may include a control program (or instruction) for carrying out the foregoing control operation, a nonvolatile memory in which the control program is installed, a volatile memory to which at least a part of the installed control program is loaded, and at least one processor or central processing unit (CPU) for executing the loaded control program. Further, such a control program may be stored in other electronic devices as well as the digital whiteboard 100.

The control program may include a program(s) achieved in the form of at least one of a basis input/output system (BIOS), a device driver, an operating system, firmware, a platform, and an application program. According to an embodiment, the application program may be previously installed or stored in the digital whiteboard 100 when the digital whiteboard 100 is manufactured, or may be installed in the digital whiteboard 100 based on application program data received from the outside when needed in the future. The application program data may for example be downloaded from an application market or the like external server to the digital whiteboard 100, but there are no limits to downloading the application program data.

Meanwhile, the processor 203 may be achieved in the form of a device, an S/W module, a circuit, a chip, etc. Further, both the process and control of the digital whiteboard 100 shown in FIG. 2 are carried out in one processor 203, but this is merely an example. According to an alternatively embodiment of the disclosure, the digital whiteboard 100 may include a controller in addition to a processor.

The display 204 may display an image corresponding to a touch of the writing instrument on the screen thereof. The display 204 may for example be achieved by various display types of liquid crystal, plasma, a light emitting diode (LED), an organic lighting emitting diode (OLED), a surface-conduction electron-emitter, a carbon nano tube, nano crystal, etc. without limitations. When the display 204 is of a liquid crystal type, the display 204 includes a liquid crystal display (LCD) panel, a backlight unit for illuminating the LCD panel, a panel driver for driving the LCD panel, etc. The display 204 may also be achieved by a self-emissive OLED panel without the backlight unit.

Below, detailed operation of the processor 203 in the digital whiteboard 100 according to an embodiment of the disclosure will be described.

In the digital whiteboard 100 according to an embodiment of the disclosure, the processor 203 compares a series of images captured by the second sensor 202, and identifies a target region which includes a motion. Here, the target region refers to an area, which is targeted to be processed for identifying the color of the writing instrument, in the image captured by the second sensor 202, i.e. an area expected to include the motion of the writing instrument. A detailed method of identifying the target region will be described later.

Next, the processor 203 identifies the color of the writing instrument within the identified target region. A method of identifying the color of the writing instrument in the target region will be described in detail.

Then, the processor 203 displays an image having the identified color at a position corresponding to the touch of the writing instrument on the screen of the display 204.

Thus, according to the disclosure, the color of the writing instrument touching the screen of the display 204 is automatically identified, and the traces of the writing instrument are displayed with the identified color on the screen, thereby giving a user an experience as if the user directly writes with the corresponding writing instrument on the digital whiteboard 100.

Further, as described above, the processor 203 of the digital whiteboard 100 according to an embodiment of the disclosure identifies the target region, in which a motion is present, within a series of images captured by the second sensor 202 based on comparison among the images, and directly identifies the color of the writing instrument in the identified target region. In other words, the processor 203 does not identify the shape, pattern, kind, and the like details of the object corresponding to the writing instrument within the image captured by the second sensor 202 and identify the color of the identified object, but rapidly extracts the target region in which a motion is present with respect to the digital whiteboard 100. Therefore, there are no needs of separately applying an object extraction algorithm or the like that requires relatively much processing operation and time, and thus a simple and rapid process is possible. Further, a color identification algorithm is applied to only the target region within the image except the other area, thereby carrying out the process more simply and rapidly. Therefore, it is possible to rapidly identify the color of the writing instrument.

Thus, according to the disclosure, the color of the writing instrument is rapidly identified before detecting the touch position of the writing instrument on the screen of the digital whiteboard 100, and the traces are displayed with the identified color, thereby allowing a user to experience writing with the corresponding color of the writing instrument immediately from the beginning of the writing without a phenomenon that the corresponding color of the writing instrument is reflected after starting the writing.

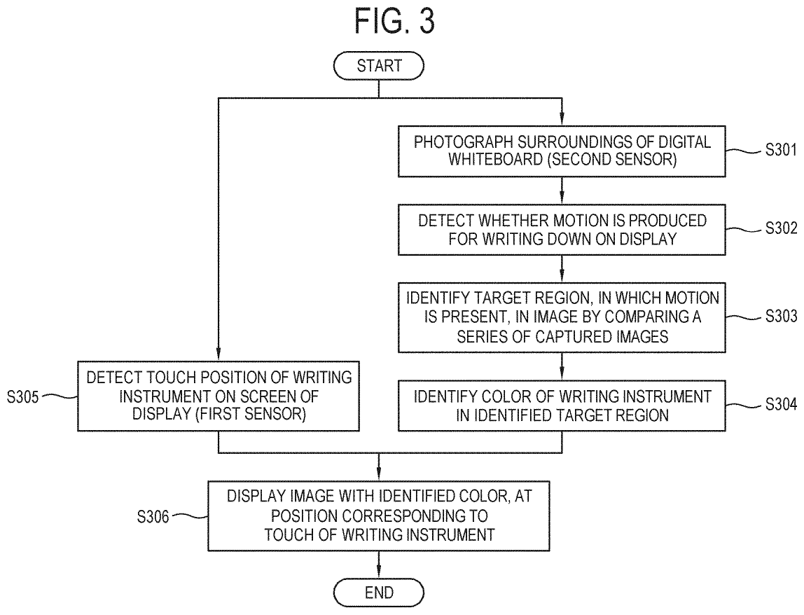

Below, the method of controlling the digital whiteboard 100 according to an embodiment of the disclosure will be described in detail with reference to FIG. 3. FIG. 3 illustrates a method of controlling the digital whiteboard 100 according to an embodiment of the disclosure.

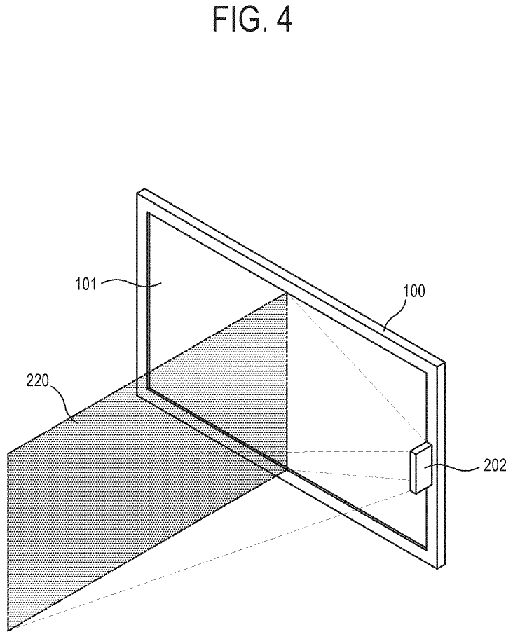

The processor 203 of the digital whiteboard 100 according to an embodiment of the disclosure controls the second sensor 202 to photograph the surroundings of the display 204 and capture an image (S301). For example, as shown in FIG. 4, the second sensor 202 may be placed at one side of the digital whiteboard 100 and photograph a predetermined area 220 (hereinafter, referred to as an ‘image-capturing area’) in a direction toward the screen 101 of the display 204. However, the place and the image-capturing area 220 of the second sensor 202 are not limited to those shown in FIG. 4, but may include any place and area where the motion of the writing instrument for writing down something on the screen 101 of the display 204 is detectable. The image obtained as the second sensor 202 photographs the surroundings of the display 204 is transmitted to the processor 203.

The processor 203, which received the image from the second sensor 202, identifies whether a motion for writing is produced with respect to the screen 101 of the display 204 (S302). As an example of the identification method, change between an image of a previous frame and an image of a current frame may be measured. For example, the processor 203 may identify that a motion is produced for writing down something, when a total amount of differences in pixel value between the two images is greater than or equal to a predetermined value. In other words, it is possible to identify whether a motion is produced or not, without specifically analyzing detailed content of an image or a specific area within an image. Here, a predetermined value refers to a preset value, and may be varied in sensitivity of motion detection depending on settings. For example, when the predetermined value is set to high, detection of a writing motion may become insensitive. When the predetermined value is set to low, the motion detection may become sensitive a little. The predetermined value may be set by a user, or may be automatically set or adjusted by the digital whiteboard 100.

As described above, it is identified that the writing motion is produced only when change between images is greater than or equal to the predetermined value, and the following process is then carried out. Therefore, the processor 203 can prevent proceeding with identifying the color of the writing instrument when not a substantial writing motion but a slight motion or change is produced.

As another example of the method of detecting (or identifying) a motion, the image of the current frame may be compared with images of a plurality of previous frames. In this regard, the following methods of selecting a comparison frame (or a reference image) when identifying the target region are all applicable, and therefore this method will be described in detail together with the method of identifying the target region.

When it is identified that a motion for writing is produced, the processor 203 identifies the target region, in which the motion is present, within the image by comparing a series of images captured by the second sensor 202.

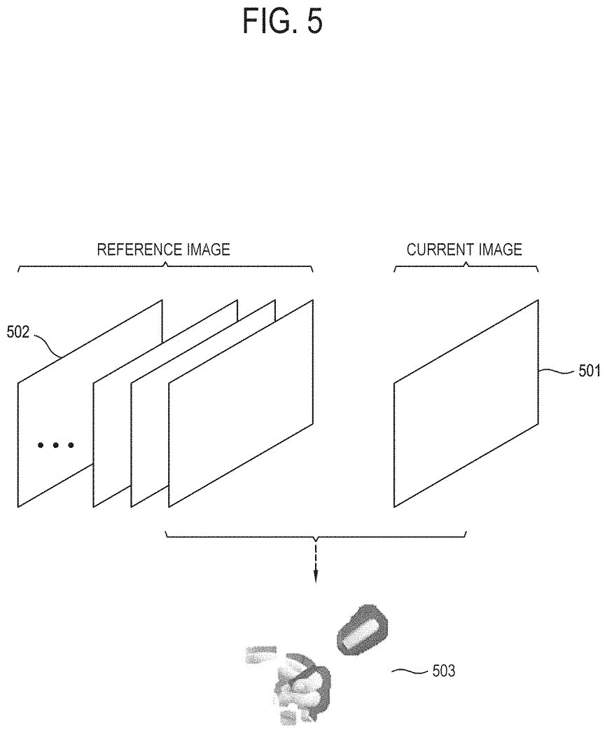

Referring to FIG. 5, the method of identifying the target region will be described in more detail.

As an example of the method of identifying the target region, the processor 203 identifies a target region 503 based on comparison between a current image 501 captured at a point in time of identifying whether a motion is produced and at least one previously captured reference image 502. Here, the reference image refers to an image captured at a point in time when a user does not write down anything on the screen 101 of the display with the writing instrument. In that case, the region 503 where a motion is substantially produced with respect to the digital whiteboard 110 is extracted from the current image by comparing the current image 501 and the reference image 502.

For example, when a user holds the writing instrument and comes near the digital whiteboard 100, the current image contains the user's hand and the writing instrument on a background corresponding to the surroundings of the screen 101 of the display 204, but the reference image contains only the background corresponding to the surroundings of the screen 101 of the display 204. Therefore, when an overlap part between the current image and the reference image is removed from the current image, only the user's hand and the writing instrument are left and the other background is removed.

Thus, when the color of the writing instrument is identified, the background corresponding to the surroundings of the display, in which a substantial motion has been absent, is not taken into account, thereby speeding up the identification of the color of the writing instrument.

The current image may be compared with only one reference image or a plurality of reference images. When only one reference image is used, the reference image may be continuously changed into a new frame at regular time intervals. When the plurality of reference images is used in identifying the target region, a range of reference images to be taken into account for identifying the target region may be variously set. For example, a predetermined number of, e.g. only ten reference images most recently captured with respect to a current point in time may be compared with the current image to identify the target region. Alternatively, all the reference images, which have been captured hitherto, may be fully used in comparison with the current image to thereby identify the target region. When the plurality of reference images is used, the reference images are differently weighted to thereby adjust a consideration degree of each reference image according to how close it is to the current time. In such a case where the plurality of reference images is used in identifying the target region, a temporary change in a background is not treated as a background because background information of more points in time is reflected in identifying the target region, thereby improving reliability of extracting the target region.

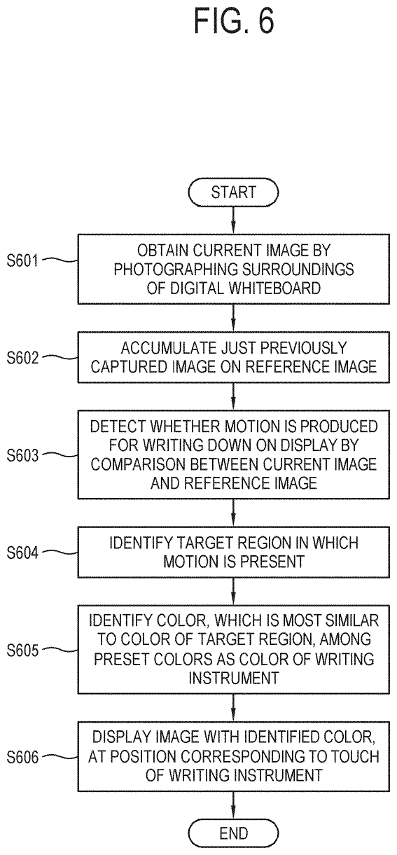

Referring back to FIG. 3, the processor 203, which identified the target region by the foregoing method, identifies the color of the writing instrument in the identified target region (S304). There are various methods of identifying the color of the writing instrument in the target region. For example, the processor 203 may identify a color, which occupies the largest area in the target region, as the color of the writing instrument. In this case, the processor 203 may obtain the greatest number of pixel values among pixel values of pixels in the target region, and thus identify the color occupying the largest area. Alternatively, the processor 203 may obtain a representative color of the target region, and identify a color, which is the most similar to the representative color of the target region, among a plurality of preset colors as the color of the writing instrument (see FIG. 6). For example, when eight colors of when red, orange, yellow, green, blue, indigo, violet, and black are set as the plurality of preset colors, the processor 203 may compare an average value of all pixels as the representative color of the target region with these eight colors and identify the most similar color as the color of the writing instrument. Further, the processor 203 may combine the above two examples. In other words, the processor 203 may re-designate the most similar color among a plurality of colors, which are previously set with regard to the pixels of the target region, as a color value of each pixel, and identify the greatest number of colors among them as the color of the writing instrument. Thus, it is possible to rapidly identify the color of the writing instrument from the target region, without specifically recognizing the detailed shape, pattern, kind, etc. of an object corresponding to the writing instrument within the image captured by the second sensor 202. Another method of rapidly identifying the color of the writing instrument from the target region will be described later.

The foregoing processes S301-S304 described above with reference to FIG. 3 refer to processes performed in the second sensor 202 and the processor 203 before the writing instrument comes near and touches the screen 101 of the display 204. Meanwhile, when the writing instrument touches the screen 101 of the display 204, the first sensor 201 detects the touch position of the writing instrument on the screen 101 of the display 204 (S305). According to an embodiment of the disclosure, the second sensor 202 and the processor 203 can rapidly carry out the processes of detecting the motion of the writing instrument moving closer to the screen 101 of the display 204 and identifying the color of the writing instrument, and therefore it is possible to identify the color of the writing instrument no later than when the first sensor 201 detects the touch position of the writing instrument. Thus, the processor 203 can display an image having an identified color at a position corresponding to the touch of the writing instrument (S306), thereby giving a user an experience as if the user writes down with the writing instrument immediately having its own color from the beginning of the writing without mirroring the color of the writing instrument only after starting the writing.

The processor 203 of the digital whiteboard 100 according to an embodiment of the disclosure may change the size of the image-capturing area 220 according to the processing speed of the processor 203 or a frame detecting speed of the second sensor 202, a distance between the image-capturing area and the second sensor 202, etc. For example, the processor 203 may set the size of the image-capturing area 220 to decrease as the speed of the processor 203 becomes higher, the frame detecting speed of the second sensor 202 becomes higher, or the distance between the image-capturing area and the second sensor 202 becomes shorter. In these cases, it is possible to reduce the size of the image-capturing area because the writing instrument moving fast is detectable and the color is extractable from the detected writing instrument even though the image-capturing area is small. Like this, when the size of the image-capturing area is reduced, the target region extracted from the image-capturing area also becomes smaller, thereby speeding up the process of identifying the color of the writing instrument within the small target region.

Alternatively, instead of changing the size of the image-capturing area 220 as described above, it may also be possible to restrict the size of a region to be analyzed in detail through a high-quality image within the image-capturing area. For example, a target region containing a motion is identified through a VGA-quality image of with regard to the whole image-capturing area 220, and then analyzed through an SVGA, HD, FHD or the like high-quality image according to the processing speed of the processor 203 or the frame detecting speed of the second sensor 202, the distance between the image-capturing area and the second sensor 202, etc., thereby restricting a region for identifying the color of the writing instrument. Thus, accuracy of identifying the color of the writing instrument is improved while keeping the speed of identification high.

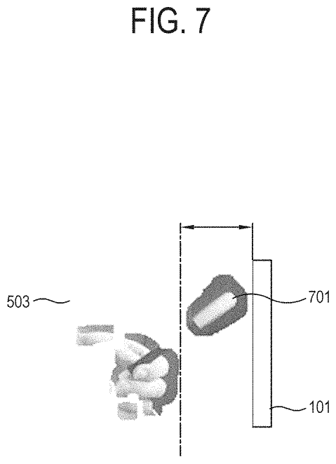

As another method of rapidly identifying the color of the writing instrument from the target region, the controller 203 of the digital whiteboard 100 according to an embodiment of the disclosure may identify the color of the writing instrument based on a distance between the writing instrument and a human body holding the writing instrument. This will be described with reference to FIG. 7.

A user is highly likely to perform writing while holding the writing instrument in the user's body, e.g. a hand and moving the writing instrument near the screen 101 of the display. In this case, a target region, in which a motion is present, may contain the user's hand as well as the writing instrument. At this time, if the color of the writing instrument is identified from the rest of the region except the region corresponding to the user's hand, it will be possible to improve reliability of identifying the color of the writing instrument.

To this end, the processor 203 may identify the color of the writing instrument based on a distance between the writing instrument and a human body holding the writing instrument. For example, based on a predetermined height from one end of the writing instrument touching the screen 101 of the display to a part of the writing instrument held by a user with a hand, the processor 203 may identify the color of the writing instrument by considering only a region 701, which comes near the display screen 101 within a predetermined height, of the target region 503. Here, the predetermined height may be set previously, may be set by an input, or may be set differently according to users.

Thus, the size of the region targeted for identifying the color of the writing instrument is reduced, thereby not only speeding up the color identification but also improving the accuracy in identifying the color the color of the writing instrument.

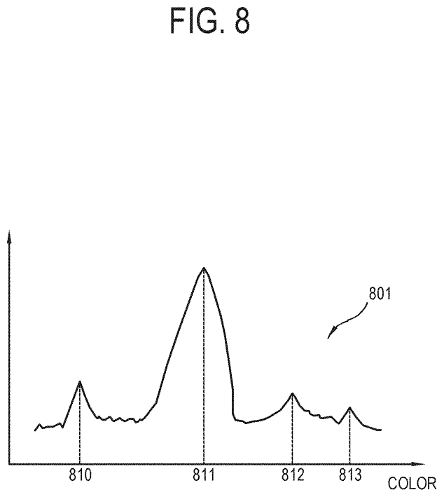

As still another method of rapidly identifying the color of the writing instrument from the target region, the processor 203 may identify the color of the writing instrument based on density of color distribution in the target region 503. This will be described with reference to FIG. 8.

FIG. 8 shows a graph in which the color information of the target region 503 is analyzed. When the color distribution of the target region 503 is as shown in the graph 801 of FIG. 8 (where, the abscissa indicates color and the ordinate indicates distribution), a color 811 has the highest density among four colors 810-813 having a relatively high degree of color distribution. Therefore, the processor 203 can identify the color 811 as the color of the writing instrument.

Thus, it is possible to improve the accuracy of identifying the color of the writing instrument while keeping the speed of identifying the color of the writing instrument. However, the method of analyzing the density of the color distribution in the target region is not limited to the foregoing graph analysis method.

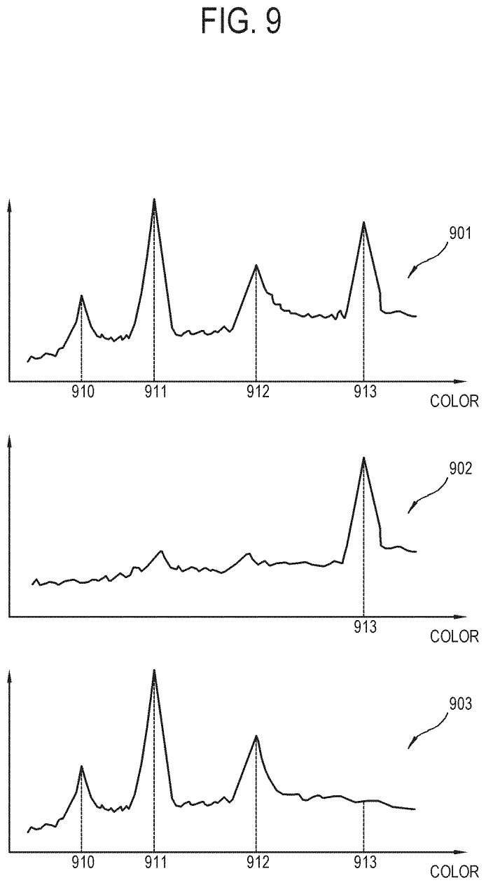

As still another method of rapidly identifying the color of the writing instrument from the target region, the processor 203 may identify the color of the writing instrument based on information in which a color component (hereinafter, referred to as a ‘noise component’) unrelated to the writing instrument is excluded from the color distribution in the target region. This will be described with reference to FIG. 9.

When the color distribution of the target region 503 is as shown in the graph 901 of FIG. 9, two colors 911 and 913 are similar in terms of showing high density values in the color distribution graph 901 of the target region 503, and it is therefore difficult for the processor 203 to clearly identify which one of the two colors as the color of the writing instrument.

At this time, the processor 203 may be referred to the information in which the noise component is excluded from the color distribution in the target region. The noise component may for example include a color component corresponding to a user's body. Specifically, when the color distribution of the color component corresponding to a user's body, for example, a hand is as shown in the graph 902, the processor 203 may draw a new graph 903 by subtracting the values of the graph 902 showing the color distribution of the color corresponding to a user's hand from the graph 901 showing the color distribution of the target region 503, and identify the color 911 having the highest density of the color distribution in the new graph 903 as the color of the writing instrument. In other words, the color 913 of the color component corresponding to the user's hand is excluded when the color of the writing instrument is identified.

Thus, it is possible to improve the accuracy of identifying the color of the writing instrument while keeping the speed of identifying the color of the writing instrument.

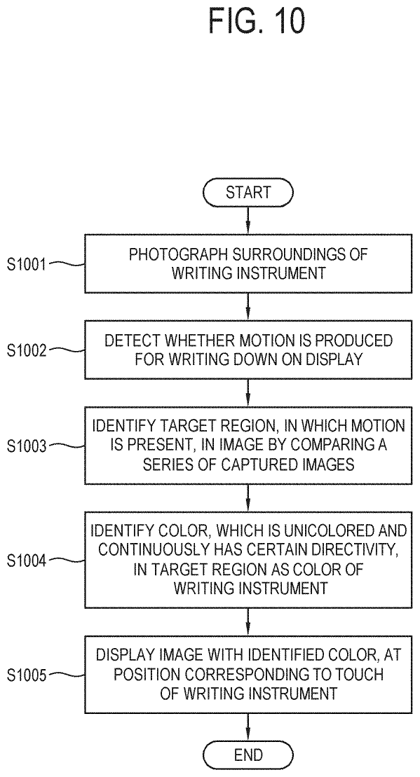

As still another method of rapidly identifying the color of the writing instrument from the target region, the processor 203 may identify a color, which is continuously shown in a predetermined direction within the target region, as the color of the writing instrument. This will be described with reference to FIG. 10.

The processor 203 of the digital whiteboard 100 according to still another embodiment of the disclosure controls the second sensor 202 to transmit an image by photographing the surroundings of the display 204 (S1001). The processor 203, which received the image from the second sensor 202, identifies whether a motion is produced to perform writing down on the screen 101 of the display 204 (S1002). When it is identified that the motion is produced to perform writing down, the processor 203 identifies the target region, in which a motion is present, within the image by comparing a series of images captured by the second sensor 202 (S1003). Detailed descriptions about operation in this stage will be omitted because all the foregoing descriptions are applicable thereto.

After identifying the target region, the processor 203 identifies a color, which is continuously shown in a predetermined direction within the target region, as the color of the writing instrument (S1004). A user of the digital whiteboard 100 tends to select a regular and typical object, for example, a bar or rectangular object rather than an irregular or untypical object when selecting an object to be used as the writing instrument among common objects. Further, the writing instrument is likely to be unicolored within its shape. In that case, the writing instrument continuously has a predetermined color in a predetermined direction within the target region, and therefore the processor 203 identify the color of the writing instrument based on this characteristic.

There are various methods of identifying a color continuously shown in a predetermined direction within the target region. For example, the pixels of the target region are regarded as nodes, and a color value of each pixel is compared with color values of neighboring pixels. The pixels having the same color value are connected as an edge to thereby draw a graph. By searching a graph, of which connection is elongated in one direction, among many graphs drawn as above, the color value of the pixel that belongs to the found graph may be identified as the color of the writing instrument.

The processor 203 displays an image, which has a color identified as described above, at a potion corresponding to the touch of the writing instrument (S1005).

Thus, the color of the writing instrument is identified based on general properties of the writing instrument, thereby improving reliability of identifying the color of the writing instrument.

The processor 203 of the digital whiteboard 100 according to still another embodiment of the disclosure may maintain a previously detected color of the writing instrument when the detection of the writing instrument is stopped and then resumed within a predetermined period of time while performing writing down by detecting the color and touch traces of the writing instrument.

While a user is writing down on the digital whiteboard 100 with the writing instrument, the user may occasionally move the writing instrument away from the screen 101 of the display 204 for a moment and resume writing down with the same writing instrument after considering something or doing another activity. In this case, it may be inefficient to newly identify the motion and color of the writing instrument whenever the writing instrument moves near the screen 101 of the display 204. Thus, the processor 203 of the digital whiteboard 100 according to still another embodiment of the disclosure may maintain the previously detected color of the writing instrument when the detection of the writing instrument is stopped and resumed within a predetermined period of time while the writing is carried out by detecting the color and touch traces of the writing instrument, thereby using the already identified color of the writing instrument again even though a user discontinuously performs writing down with one writing instrument. Here, there are no specific limits to the predetermined period of time. The predetermined period of time may be previously set, may be voluntarily set by a user, or may be automatically or adaptively set and modified by the processor.

Thus, when a user discontinuously performs writing down with one writing instrument, it is possible to use the already identified color of the writing instrument again as it is, thereby rapidly identifying the color of the writing instrument.

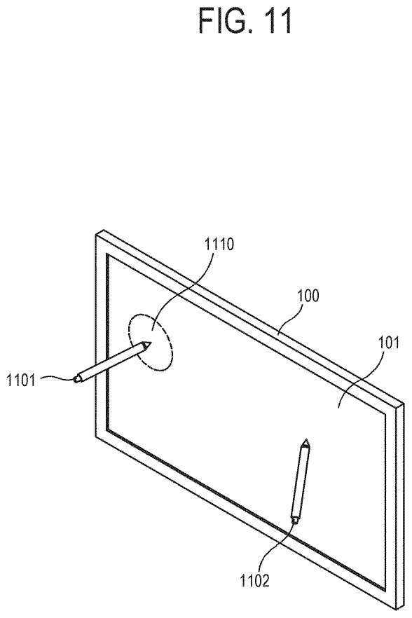

The digital whiteboard 100 according to the disclosure allows one user or a plurality of users to do writing down simultaneously using a plurality of writing instruments. In this case, the processor 203 of the digital whiteboard 100 according to still another embodiment of the disclosure may detect motions of writing instruments by respectively assigning individual regions in the image to a first writing instrument and a second writing instrument. This will be described with reference to FIG. 11.

FIG. 11 illustrates a situation that a second user moves a second writing instrument 1102 near the screen 101 of the digital whiteboard 100 to write down with the second writing instrument 1102 while a first user is writing down on the screen 101 of the digital whiteboard 100 with a first writing instrument 1101. In this case, the processor 203 of the digital whiteboard 100 according to an embodiment of the disclosure may detect the motion, color and touch position of the second writing instrument 1102 by the foregoing method, e.g. the method described with reference to FIG. 3. In this case, when the processor 203 detects the motion or touch position of the second writing instrument 1102, it may be efficient that the motion or touch potion of the second writing instrument 1102 is detected with regard to only the rest of the region except a region 1110 corresponding to the motion or touch position of the first writing instrument 1101. In other words, the processor 203 may detect the motion of each writing instrument by respectively assigning individual regions in images to the first writing instrument and the second writing instrument. In this case, if only one second sensor 202 is provided at one side of the display, the second sensor 202 may not identify the second writing instrument 1102 when the first writing instrument 1101 and the second writing instrument 1102 are overlapped. Therefore, the plurality of second sensors 202 may be placed at different positions of the digital whiteboard 100.

Thus, it is possible to rapidly identify the color of the writing instrument even when the plurality of writing instruments is used.

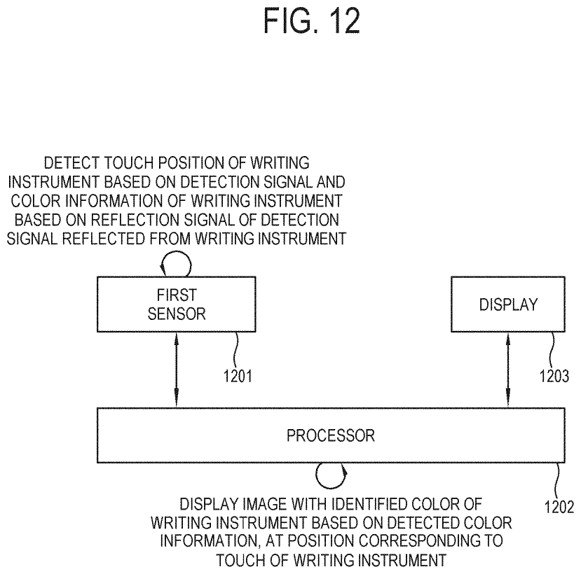

Meanwhile, the foregoing embodiments described that the first sensor 201 for detecting the touch position of the writing instrument, and the second sensor 202 for obtaining a photographed image to be used as basic data in analyzing the motion and color of the writing instrument are separately provided. However, a digital whiteboard 1300 according to still another embodiment of the disclosure may include only one sensor to detect both the touch position and color information of the writing instrument. This will be described with reference to FIG. 12.

FIG. 12 illustrates a configuration of a digital whiteboard 1300 according to still another embodiment of the disclosure. The digital whiteboard 1300 according to this embodiment of the disclosure includes a first sensor 1201, a processor 1202, and a display 1203. Among them, the processor 1202 and the display 1203 will not be repetitively described because the foregoing descriptions about FIG. 2 are applicable thereto.

The first sensor 1201 detects the touch position of the writing instrument on the display 1203 based on a detection signal, and the color of the writing instrument information based on a reflection signal, i.e. the detection signal reflected from the writing instrument. Here, the detection signal refers to a signal, which has a certain wavelength and is emitted, and may for example include an infrared (IR) ray or a radio frequency (RF) wave. The detection signal may include a plurality of signals different in wavelength from each other.

When the detection signal is the IR or RF signal, the first sensor 1201 may include an IR sensor or an RF sensor. The first sensor 1201 may further include a signal emitter for emitting signals and a signal receiver for receiving the emitted signals. Further, the first sensor 1201 may include a sensor having an array form. In this case, the number of sensors may be varied depending on the size of the display 1203 or required accuracy of color identification.

When the first sensor 1201 detects the touch position of the writing instrument on the display 1203 based on the detection signal and the color information of the writing instrument based on the reflection signal obtained by reflecting the detection signal from the writing instrument, the processor 1202 may display an image having the writing instrument, of which the color is identified based on the detected color information, at a position corresponding to the touch of the writing instrument on the screen of the display 1203.

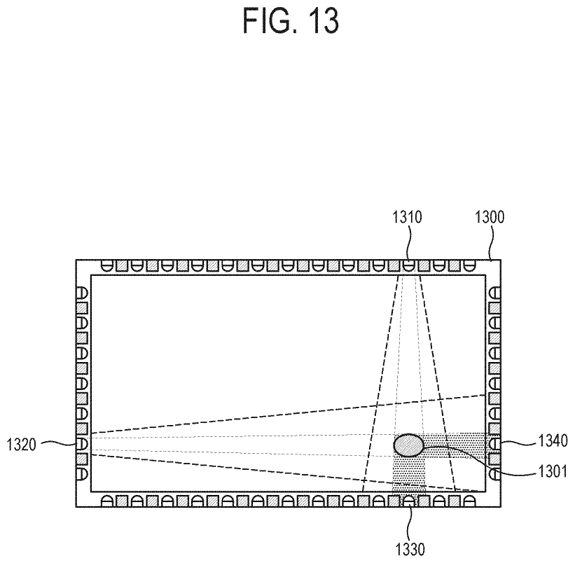

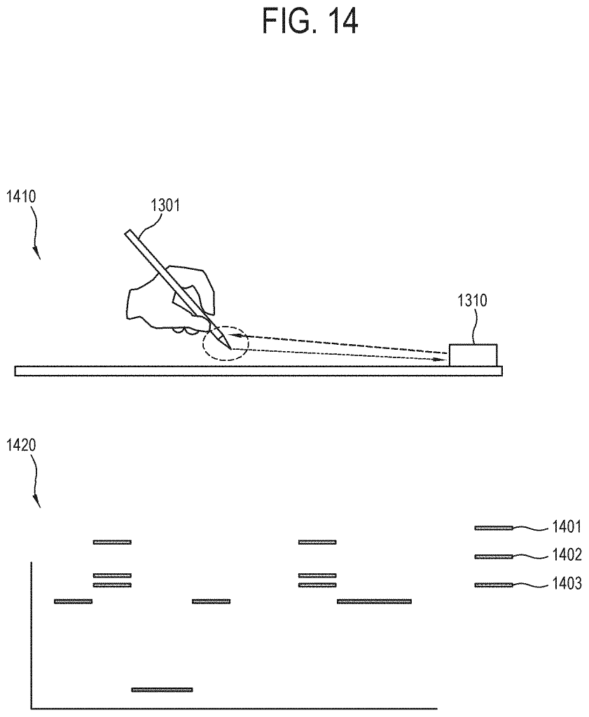

Below, operation of the digital whiteboard 1300 with the foregoing configuration according to still another embodiment of the disclosure will be described in detail with reference to FIGS. 13 and 14.

FIG. 13 illustrates an embodiment that the first sensor 1201 of the digital whiteboard 1300 according to this embodiment of the disclosure includes a sensor array arranged along the outer edges of the screen of the display 1203. For convenience of description, it will be assumed that the sensors are the IR sensors. In this case, the first sensor 1201 may include both an IR emitter and an IR receiver.

When the first sensor 1201 includes the IR sensor array arranged as shown in FIG. 13, the processor 1202 can detect the touch position of the writing instrument. For example, as shown in FIG. 13, when a writing instrument 1301 touches the screen of the display 1203, IR signals emitted from IR emitting sensors 1301 and 1320 corresponding to the touch position do not reach IR receiving sensors 1330 and 1340 provided at the opposite side. Based on this information, the processor 1202 can detect touch coordinates of the writing instrument.

A method that the first sensor 1201 detects the color of the writing instrument information will be described with reference to FIG. 14. As shown in ‘1410’ of FIG. 14, when the writing instrument 1301 enters a detection region of an IR sensor 1301 while the detection of the IR sensor 1310 is performed above the screen of the display 1203, the IR sensor 1310 may receive a reflection signal as the detection signal is reflected from the writing instrument. The reflection signal reflected from the writing instrument may have properties different according to the colors of the writing instrument. For example, the strength of the reflection signal may be varied depending on the color of the writing instrument. In this case, the IR sensor 1310 may detect the color information of the writing instrument based on the strength of the received reflection signal, and the processor 1202 may identify the color of the writing instrument based on the color information received from the IR sensor 1310.

The detection signal may include a plurality of signals different in wavelength. For example, the IR sensor 1310 may emit detection signals having three wavelengths of 700 nm (1401), 800 nm (1402), and 900 nm (1403). In that case, the reflection signal reflected from the writing instrument may have different properties according to the colors of the writing instrument, and the properties may also be varied depending on the wavelengths of the detection signal. In other words, when the strength of the reflection signal is varied depending on the color of the writing instrument, the strength of the reflection signal is also varied depending on the wavelength of the detection signal.

For example, when the writing instrument is black, the strength of the reflection signal reflected from the black writing instrument may be different according to the wavelengths 1401-1403 of the detection signal as shown in the graph 1420 of FIG. 14. Because the strength of the reflection signal different according to the wavelengths of the detection signal are varied depending on the color of the writing instrument, the processor 1202 can identify the color of the writing instrument by analyzing the strength of the reflection signal according to the wavelengths of the detection signal.

Thus, only one sensor is enough to detect both the color and touch position of the writing instrument, thereby reducing production costs of the digital whiteboard 1300 and improving a design degree of freedom as compared with those of individually provided sensors. Further, it is possible to more rapidly identify the color of the writing instrument because the color of the writing instrument is detectable without capturing an image.

1. A digital whiteboard comprising:
a display;
a first sensor configured to detect a touch position of a writing instrument with regard to a screen of the display;
a second sensor configured to obtain an image based on image capturing; and
a processor configured to
identify a target region, in which a motion is present, in the image by comparing a series of images captured by the second sensor,
identify a color of the writing instrument in the identified target region, and
display an image comprising the identified color, at a position corresponding to a touch of the writing instrument on the screen of the display.

2. The digital whiteboard according to claim 1, wherein the processor identifies a color, which is most similar to a color of the target region, among a plurality of preset colors as the color of the writing instrument.

3. The digital whiteboard according to claim 1, wherein the processor identifies the color of the writing instrument based on a distance between the writing instrument and a human body holding the writing instrument.

4. The digital whiteboard according to claim 1, wherein the processor identifies the color of the writing instrument based on density of color distribution in the target region.

5. The digital whiteboard according to claim 1, wherein the processor identifies the color of the writing instrument based on information in which a color component unrelated to the writing instrument is excluded from color distribution of the target region.

6. The digital whiteboard according to claim 1, wherein the processor identifies a color, which is continuously shown in a predetermined direction within the target region, as the color of the writing instrument.

7. The digital whiteboard according to claim 1, wherein the processor maintains a previously detected color of the writing instrument based on detection of the writing instrument resumed within a predetermined period of time after stopping the detection of the writing instrument.

8. The digital whiteboard according to claim 1, wherein the processor detects motions of a first writing instrument and a second writing instrument by assigning individual regions in the image to each writing instrument.

9. A digital whiteboard comprising:
a display;
at least one first sensor configured to detect a touch position of a writing instrument on the display based on a detection signal, and color information of the writing instrument based on a reflection signal of the detection signal reflected from the writing instrument; and
a processor configured to display an image comprising the writing instrument, of which a color is identified based on the detected color information, at a position corresponding to a touch of the writing instrument on a screen of the display.

10. The digital whiteboard according to claim 9, wherein the detection signal comprises a plurality of signals different in wavelength.

11. The digital whiteboard according to claim 9, wherein the first sensor comprises a signal emitter configured to emit an infrared signal, and a signal receiver configured to receive the infrared signal.

12. A method of controlling a digital whiteboard, comprising:
identifying a target region, in which a motion is present, in an image by comparing a series of captured images;
identifying a color of the writing instrument in the identified target region;
identifying a touch position of the writing instrument on a screen of the digital whiteboard; and
displaying an image comprising the identified color, at a position corresponding to a touch of the writing instrument on the screen of the digital whiteboard.

13. The method according to claim 12, wherein the identifying the color of the writing instrument comprises identifying a color, which is most similar to a color of the target region, among a plurality of preset colors as the color of the writing instrument.

14. The method according to claim 12, wherein the identifying the color of the writing instrument comprises identifying the color of the writing instrument based on a distance between the writing instrument and a human body holding the writing instrument.

15. The method according to claim 12, wherein the identifying the color of the writing instrument comprises identifying the color of the writing instrument based on density of color distribution in the target region.
